(19) United States
(12) Patent Application Publication
(10) Pub. No.: US 2014/0279391 A1
(43) Pub. Date: Sep. 18, 2014

(54) ACCOUNT MANAGER USER INTERFACE AND GUIDANCE MODEL

(71) Applicants: Suzanne Gallo, Lake Forest, IL (US); Daniel Roland, Mt. Pleasant, WI (US); Shilpa Wadhera, Vernon Hills, IL (US); Alfredo Osorio, Lake Forest, IL (US)

(72) Inventors: Suzanne Gallo, Lake Forest, IL (US); Daniel Roland, Mt. Pleasant, WI (US); Shilpa Wadhera, Vernon Hills, IL (US); Alfredo Osorio, Lake Forest, IL (US)

(73) Assignee: Discover Financial Services LLC, Riverwoods, IL (US)

(21) Appl. No.: 13/841,064

(22) Filed: Mar. 15, 2013

(51) Int. Cl. G06Q 40/02; G06F 3/0481

(52) U.S. Cl. CPC G06Q 40/025; G06F 3/04817
USPC 705/38

(57) ABSTRACT

Systems and methods are provided that cause a single user interface to be accessible by an account manager, where the single user interface is capable of displaying biographical information about a customer, displaying financial history and information about the customer, displaying a credit bureau summary portion, integrating additional calculators into the user interface, providing an offer result history, providing a banking information indicator, creating decision fields in the user interface that utilize new data sources, and/or providing the ability to present dynamic scripting to the account manager based on account attributes and other attributes and data.

### BACKGROUND

This disclosure relates to payment networks and, in particular, to an account manager user interface and guidance model.

Customers of financial institutions and/or payment card issuers sometimes become delinquent on their accounts. For example, a credit card customer may have a large balance on the credit card account that the customer is unable to pay in a timely manner. The financial institutions and/or payment card issuers may seek to identify these customers and reach out to them to possibly negotiate an arrangement to get the account back to current status or keep the account from going delinquent.

In conventional systems, a customer's biographical, financial, and historical data is stored in separate databases and is only accessible via separate user interface screens. When attempting to negotiate with an at-risk customer, an account manager must navigate through a series of user interface screens to view all of the different information about the customer that may be useful during the negotiation. Since the account manager only has a short amount of time to interact with the customer, the negotiation may be stalled or derailed. Also, typically the customer is not motivated to speak with the account manager.

### SUMMARY

One embodiment provides a computer-implemented method for presenting a user interface on a computer display to an account manager of a financial institution, where a customer is a member of the financial institution. The method includes: displaying, in a single user interface screen: an offer timeline of offers provided to the customer, wherein each offer is displayed as an icon in the offer timeline that corresponds to a result of the offer; a timeline corresponding to payment history of the customer; a graphical representation of the customer's debt over time; indicators of the customer's bank account balances and loan balances; an indicator of the customer's credit score; one or more indicators corresponding to one or more personal situations of the customer; one or more offers for the account manager to provide to the customer based on one or more of the offer timeline, the payment history of the customer, the customer's debt over time, the customer's bank account balances and loan balances, the customer's credit score, and the one or more personal situations of the customer; and a customer category interface, wherein when the account manager selects a category corresponding to the customer, the single user interface screen displays one or more verbal cues for negotiation corresponding to the selected category.

Another embodiment provides a computer-implemented method for negotiating with a customer of a financial institution. The method includes: initiating, from a computer system associated with the financial institution, a telephone call to the customer; displaying, in a single user interface screen on the computer system: an offer timeline of offers provided to the customer, wherein each offer is displayed as an icon in the offer timeline that corresponds to a result of the offer, a graphical representation of the customer's debt over time, one or more indicators corresponding to one or more personal situations of the customer, and one or more offers to provide to the customer based on one or more of the offer timeline, the customer's debt over time, and the one or more personal situations of the customer; receiving, via the single user interface screen, a selection of a first customer category for the customer; based on the first customer category, displaying, in the single user interface screen, a first set of verbal cues for negotiating with the customer; receiving, via the single user interface screen, a selection of a second customer category for the customer; and, based on the second customer category, displaying, in the single user interface screen, a second set of verbal cues for negotiating with the customer.

Yet another embodiment provides a system comprising one or more databases and a computing device executing one or more processors configured to generate a single user interface screen. The one or more databases store: customer biographical information, customer payment history information, customer bank account balance and loan balance information, customer statement information, customer credit score information, and information related to one or more offers previously presented to a customer and one or more outcomes corresponding to presenting the one or more offers to the customer. The single user interface screen comprises: an offer timeline of offers provided to the customer, wherein each offer is displayed as an icon in the offer timeline that corresponds to a result of the offer; a timeline corresponding to payment history of the customer; a graphical representation of the customer's debt over time; indicators of the customer's bank account balances and loan balances; an indicator of the customer's credit score; one or more indicators corresponding to one or more personal situations of the customer; one or more offers for the account manager to provide to the customer based on one or more of the offer timeline, the payment history of the customer, the customer's debt over time, the customer's bank account balances and loan balances, the customer's credit score, and the one or more personal situations of the customer; and a customer category interface, wherein upon receiving a selection of a category corresponding to the customer, the single user interface screen displays one or more verbal cues for negotiation corresponding to the selected category.

### BRIEF DESCRIPTION OF THE DRAWINGS

FIG. 1 is a conceptual diagram of a payment network, according to one embodiment of the disclosure.

FIG. 2 is a conceptual diagram illustrating different data sources from which data can be collected to be displayed in a user interface available to an account manager, according to one embodiment of the disclosure.

FIG. 3 is a conceptual diagram illustrating screenshot of a user interface available to an account manager, according to one embodiment of the disclosure.

FIG. 4 is a conceptual diagram illustrating an alternative view of payment information, according one embodiment of the disclosure.

FIG. 5 is a conceptual diagram illustrating different offer outcomes, according one embodiment of the disclosure.

FIG. 6 is a conceptual diagram illustrating additional information about a particular offer, according one embodiment of the disclosure.

FIGS. 7A-7B are conceptual diagrams illustrating income and debt over time, respectively, according embodiments of the disclosure.

FIGS. 8A-8B are conceptual diagrams illustrating income sources and debt sources, respectively, according embodiments of the disclosure.

FIG. 9 is a conceptual diagram illustrating credit score trends, according one embodiment of the disclosure.

FIG. 10 is a conceptual diagram illustrating a drop-down menu for selecting different customer situations, according one embodiment of the disclosure.

FIG. 11 is a conceptual diagram illustrating an interface for inputting additional information about a particular customer situation, according one embodiment of the disclosure.

FIG. 12 is a conceptual diagram illustrating an interface for different solutions and/or benefits that an account manager can provide to customer, according one embodiment of the disclosure.

FIG. 13 is a conceptual diagram illustrating additional details about the result of an offer made to a customer, according one embodiment of the disclosure.

FIG. 14 is a conceptual diagram illustrating the benefits to the customer of a particular treatment/offer, according one embodiment of the disclosure.

FIG. 15 is a flow diagram of method steps for an account manager to interact with a user interface when contacting a customer, according to one embodiment of the disclosure.

FIG. 16 is an example of a computing device configured to implement one or more embodiments disclosed herein, according to one embodiment of the disclosure.

### DETAILED DESCRIPTION

The following examples further illustrate embodiments of the disclosure but, of course, should not be construed as in any way limiting its scope.

Embodiments of the disclosure relate to a tool that allows account managers to utilize real-time information to service accounts. According to some embodiments, a user interface panel, displayed on a single user interface, displays treatment recommendations and/or offers based on historical customer information and a cardmember's current situation.

According to some embodiments, based on a combination of historical and current data, the user interface provides the account manager with customer-appropriate account information, treatments/offers, and verbal negotiation cues, allowing the account manager to focus on negotiating rather than on navigating various screens, as is the current practice. By freeing up the account manager to negotiate rather than navigate through multiple screens, the account manager is able to remain customer-focused, increasing both collector efficiency and conversion rate.

Embodiments of the disclosure provide for a single user interface panel accessible by the account manager that is capable of: displaying a credit bureau summary screen, integrating additional calculators, providing a banking information indicator, creating decision fields in the user interface that utilize new data sources, and/or providing the ability to present dynamic scripting based on account attributes, among other things.

In some embodiments, displaying a credit bureau summary screen includes: displaying positive/negative display indicators next to each category on the summary screen, providing credit bureau trending data, providing an arrow graphic to display direction of trend, introducing additional credit bureau information into the summary screen, and/or removing unnecessary information from the credit bureau summary screen, among other things. In some embodiments, integrating additional calculators includes an ability to launch various calculators from the user interface. In some embodiments, providing a banking information indicator includes: enabling an indicator if banking information is present, graying-out the indicator if no banking information is on file, and/or providing the ability to launch a bank history screen from the banking information available indicator.

Some embodiments provide the ability to present dynamic “scripting” based on account attributes. Scripting refers to a list of verbal cues provides to the account manager to help the account manager negotiate with the cardmember. Scripting can be based on batch-driven and real-time attributes. Scripting is dynamically updated based on real-time account actions, provides the capability to update scripting verbiage without a special verbiage install, and provides the ability to present dynamic rebuttals based on account attributes. Rebuttals can be based on batch-driven and real-time attributes, can be dynamically updated based on real-time account actions, and can provide the ability to update rebuttal verbiage without a special verbiage install.

Advantageously, embodiments of the disclosure utilize a new user interface architecture that is able to help account managers identify targeted treatments/offers based on customer segment and situation, deploy treatments/offers through the negotiation process with guided scripting, and synthesize account information from multiple data sources. From a business perspective, embodiments minimize charge off losses.

FIG. 1 is a conceptual diagram of a payment network 100, according to one embodiment of the disclosure. As shown, the payment network 100 includes a financial institution 110, an issuer 112, acquirers 104, merchants 106, 114, payers 108, merchant database 116, and transaction database 118. In one embodiment, the financial institution 110 and the issuer 112 comprise a single entity, labeled service provider 102. In other embodiments, the financial institution 110 and the issuer 112 are separate entities. Each of the financial institution 110, the issuer 112, the acquirers 104, the merchants 106, and the service provider 102 may be implemented as one or more computerized systems that include one or more processors and one or more memories storing instructions executed by the one or more processors.

As described, in one embodiment, the service provider 102, such as Discover Financial Services of Riverwoods, Ill., directly maintains the relationship with some merchants 114. In another embodiment, the service provider 102 interacts with merchants 106 through acquirers 104. Acquirers 104 act as an intermediary between the merchants 106 and the service provider 102 by maintaining a relationship with the merchants 106 on behalf of the service provider 102. The service provider 102 may have limited data for the merchants 106 acquired because the relationship with the merchants 106 is primarily owned by the acquirers 104.

A payer 108 is issued a payment card from an issuer 112. The financial institution 110 provides financial backing for the payment card 112. When a payment is made by the payer 108 at the merchant 106 or 114, transaction data for the transaction is stored in transaction database 118. For example, the transaction database 118 may include transaction amounts, transaction dates, and transaction counts for each merchant, among other things.

In some embodiments, apart from the transactional data, the service provider 102 also requests from the acquirers 104 and merchants 106 to submit registration information. The registration information includes data elements as specified in certain operating regulations. Examples of data elements include location information, contact information, merchant category information, and processor characteristics. The data elements are stored in merchant database 116.

According to embodiments of the disclosure, at times a payer 108 may be delinquent on their account or may be at risk for becoming delinquent on their account with issuer 112. Account managers at the issuer 112 and/or service provider 102 may then contact these payers 108 and in an effort to bring the accounts current or keep the accounts from becoming delinquent. The account mangers may utilize a collection tool, described herein as a user interface, in an effort to negotiate payment arrangements to bring the account current and/or to keep account current. As described in greater detail herein, embodiments of the disclosure provide a user interface dashboard for account managers to contact and negotiate with these at-risk payers.

FIG. 2 is a conceptual diagram illustrating different data sources from which data can be collected to be displayed in a user interface 202 available to an account manager, according to one embodiment of the disclosure.

As shown, the data may include cardmember information 206, a memo database 208, payment history 212, adjustment recommendations 214 (also referred to as “offers”), statement data 216, a payment utility 218, a contact management system 220, and credit data 222. The cardmember information 206 includes basic identifying information about the cardmember, such as name, address, social security number, date of birth, gender, marital status, etc. The memo database 208 includes any notes or memos associated with a particular cardmember. According to various embodiments, the payment history 212 includes payment dates, amounts for cardmembers, and/or method of payment. The adjustment recommendations 214 include possible adjustment and/or negotiation options/offers available for the account manager to provide to the cardmember. Statement data 216 includes various data from cardmember statements, including transactions, transaction amounts, statement dates, statement amounts, etc. The payment utility 218 provides pending payment data. The contact management system 220 provides phone numbers for the cardmembers and a utility for an account manager to initiate a call to a cardmember. Credit data 222 includes data from the major credit bureaus, such as one or more credit scores for the cardmember.

The various data sources described above can be coupled to a screen generator 210, executed by a one or more processors in computing device, configured to generate the user interface 202 and/or guidance screen 204. In some embodiments, the user interface 202 and guidance screen 204 comprise one user interface.

In some embodiments, the user interface 202 is responsible for cardmember enrollment, payment adjustments, editing of cardmember information, adding exception statuses, among others. In some embodiments, the guidance screen 204 is responsible for displaying payment and offer history, displaying financial information, displaying available programs and treatments, recording acceptances and declines of offers, displaying “scripting” guidelines (described in greater detail below), and data capture, among others.

FIG. 3 is a conceptual diagram illustrating screenshot of a user interface 300 available to an account manager, according to one embodiment of the disclosure. According to various embodiments, the user interface 300 allows account managers able to view a cardmember's financial situation, edit various fields, provide solutions and/or offers to cardmembers, indicate whether a solution/offer was accepted or declined, classify and/or categorize cardmembers, and/or manually update the fields as necessary.

As shown, the user interface 300 displays an account number 302, a name 304, a date 305 a cardmember registered with a website for the financial institution (if any), a joint cardmember name (if any), an address 305, a authorized third party name 306, an amount now due 308, payment information 310, banking information 312, and offer accept/decline history 314. According to various embodiments, any one of account number 302, name 304, joint cardmember name (if any), address 305, authorized third party name 306, amount now due 308, payment information 310, banking information 312, and/or offer accept/decline history 314 may not be displayed in the user interface 300. In some embodiments, once an account manager closes the user interface 300 and leaves the account, all info should be updated before the next contact with that cardmember. For example, if an account manager disconnects with a cardmember and then the cardmember calls back five minutes later, the user interface 300 would show the most recent data collected on the prior call.

The user interface 300 may also be configured to display an indicator for various elements with a selection box/radio button to display adjustments available when ongoing arrangements are secured. Example elements include available adjustable late fees, available adjustable overlimit fees, available adjustable finance charges, available adjustable late fees with ongoing arrangements, available adjustable overlimit fees with ongoing arrangements, and/or available adjustable finance charges with ongoing arrangements.

The user interface 300 may also be configured to display a credit quality index score 314 in a scaled display. In some embodiments, the actual credit score is not displayed. In other embodiments, the credit score is displayed as a number.

The user interface 300 may also be configured to display a frame 316 indicating number of days remaining in the cardmembers statement cycle and a number of charge off days.

As described, the user interface 300 displays payment information 310 and offer accept/decline history 314. The payment information 310 may be presented on a graph by month (x axis) versus payments received (y axis), as shown in FIG. 3. FIG. 4 is a conceptual diagram illustrating an alternative view of payment information 310, according one embodiment of the disclosure.

In some embodiments, the account manager can hover over or click on a particular payment to view additional information about the payment, such as payment date, amount due, amount paid and method of payment (e.g., mail, CTC (cost-to-company), ACH (Automated Clearing House), online, phone, IVR (interactive voice response), bank wire, DPP (direct payment plan), etc.).

In the offer accept/decline history 314, a timeline of offers previously provided to the cardmember is displayed, along with an indicator of whether the cardmember accepted/declined the offer. FIG. 5 is a conceptual diagram illustrating different offer outcomes, according one embodiment of the disclosure. Example outcomes include offer accepted, offer declined, no offer made, payment accepted, promised payment, payment due, returned payment, pay date, and other financial event. The different outcomes may be displayed as different icons and/or may be color coded. For example, indicators within the chart may use a color-coded system to identify different combinations of various variables, including: payment made, promise to pay, broken promise, returned payment, and payments received after due date but before cycle date. FIG. 6 is a conceptual diagram illustrating additional information about a particular offer, according one embodiment of the disclosure. In some embodiments, the account manager can hover a mouse or click on a particular offer to view additional details about the offer, such as date, call time, name of the person to whom the offer was made, notes about the negotiation, and whether the offer was accepted, declined, or had another result.

The user interface 300 may also be configured to display the cardmember's financial status 318. The financial status 318 includes income 320 over time, debt 322 over time, funds sources 324, and debt sources 326. According to various embodiments, any one of income 320 over time, debt 322 over time, funds sources 324, and/or debt sources 326 may not be displayed in the user interface 300. FIGS. 7A-7B are conceptual diagrams illustrating income and debt over time, respectively, according embodiments of the disclosure. As shown, an account manager can hover over or click on a particular point in time to view the cardmember's income (FIG. 7A) and/or debt (FIG. 7B) at that particular time. In one embodiment, a cardmember's debt over time is displayed in the interface, but the cardmember's income over time is not displayed. In another embodiment, a cardmember's income over time is displayed in the interface, but the cardmember's debt over time is not displayed. In other embodiments, a cardmember's income and debt over time are displayed in the interface, or neither is displayed. FIGS. 8A-8B are conceptual diagrams illustrating income sources and debt sources, respectively, according embodiments of the disclosure. The income sources shown in FIG. 8A may include source of funds, dollar amounts, percentages of total, a range that is estimated or captured from cardmember, and/or a date stamp from when the income information was last refreshed. The debt sources shown in FIG. 8B may include different types of debt, trade line source in aggregate, monthly minimum payments in aggregate for the trade line type, and/or a percentage of total debt.

As described, the user interface 300 may also be configured to display banking information 312. The banking information 312 includes assets-versus-debt, credit card balances and limits, bank account balances, and loan balances. For each account, an indicator may be displayed to indicate if the account is delinquent, including the level of delinquency, if the account is charged off, and/or whether there are any open arrangements on the account.

The bank information 312 may also be divided into bank information for the financial institution for which the account manager is responsible 327 and/or all other financial institutions 328.

The user interface 300 may also be configured to display an indicator of credit score trend 330. FIG. 9 is a conceptual diagram illustrating credit score trends, according one embodiment of the disclosure. Over a certain period of time (for example, six months), if the credit score is increasing, an upwards arrow is displayed, if the credit score is decreasing, a downwards arrow is displayed, and if the credit score remains generally constant, a sideways arrow is displayed.

The user interface 300 may also be configured to display specific customer situations 332. Examples of customer situations 332 include: active military, additional expenses, deceased, divorce, disputing charges, filing bankruptcy, fixed income, illness, no statement, out of work, oversight, overextended, reduced income, student, or other situations. FIG. 10 is a conceptual diagram illustrating a drop-down menu for selecting different customer situations, according one embodiment of the disclosure. For some of the particular customer situations, additional information may be provided via the user interface. FIG. 11 is a conceptual diagram illustrating an interface for inputting additional information about a particular customer situation, according one embodiment of the disclosure. For example: if fixed income selected, the user interface displays income capture fields; if out of work selected, the user interface displays income capture fields; if reduced income selected, the user interface displays income capture field; and, if student selected, the user interface displays graduation date capture field.

The user interface 300 may also be configured to display solutions/benefits 334 to provide to the customer. FIG. 12 is a conceptual diagram illustrating an interface for different solutions and/or benefits that an account manager can provide to customer, according one embodiment of the disclosure. The solutions/benefits 334 shown may be based on various factors of the user's financial history and particular situation. For each displayed treatment solution/offer, an accept icon and a decline icon are shown, as shown in FIG. 12. In some embodiments, once an offer is made and declined by the customer, the offer and decline should be recorded and then displayed real-time in the offer accept/decline history 314. Additional information about the offer and result of the offer can be displayed. FIG. 13 is a conceptual diagram illustrating additional details about the result of an offer made to a customer, according one embodiment of the disclosure.

In some embodiments, when an individual solution/offer is highlighted and/or selected, the user interface 300 displays below the individual solution/offer, the annual and monthly monetary benefits of that solution/offer are displayed in a benefits section below the solution/offer, as shown in FIG. 14. FIG. 14 is a conceptual diagram illustrating the benefits to the customer of a particular solution/offer, according one embodiment of the disclosure. The benefits can be used by the account manager in an attempt to persuade the customer to accept the solution/offer.

The user interface 300 may also be configured to display a “script” 336 for the account manager to follow when negotiating with the cardmember. In one embodiment, the customers can be categorized into broad categories. Some examples include: assist with more time and money, provide tangible help now, build relationship, generate communication, and special handling. The examples provided are merely meant to show examples of categories and do not limit the scope of the disclosure. In the example shown in FIG. 3, the categories are “Conversation Categories.” Other customer categories may be provided is other embodiments of the disclosure. The account manager can select one of the broad categories. In response, various verbal cues, or “scripts,” may be displayed in the user interface to the account manager based on the selected category. For example, the verbal cues may include acknowledgment phrases, transitional phrases, solution-based questions, and benefits-based rebuttals. The account manager may use these verbal cues when negotiating with the customer. In some embodiments, the account managers can select a different category for the customer throughout the course of the call, and the corresponding scripts/cues refresh based on the updated customer category.

FIG. 15 is a flow diagram of method steps for an account manager to interact with a user interface when contacting a customer, according to one embodiment of the disclosure.

As shown, the method 1500 begins at step 1502, where an account manager initiates a call to a customer. At step 1504, various customer information is displayed in a single user interface screen to the account manager, as described above. The customer information may include a name, account number, offer acceptance/denial history, payment history, customer financial status, customer account information, credit score, payment cycle information, and/or indications of specific customer situations.

At step 1504, the account manager provides an offer to the customer based on the customer information displayed in the user interface. In some embodiments, the listing of offers available to the account manager to provide to the customer is based on the specific customer information associated with the particular customer being contacted. If, at step 1508, the offer is accepted, then the method 1500 proceeds to step 1510. At step 1510, offer acceptance is recorded in a customer offer history.

If, at step 1508, resistance to the offer is encountered, then the method 1500 proceeds to step 1512. At step 1512, the account manager selects a customer category. At step 1514, scripting guidance is displayed to the account manager based on the selected customer category. At step 1516, account manager negotiates with the customer, for example, using the scripting guidance. In some embodiments, during the negotiation, the customer's category may change, at which point the account manger can select an updated customer category, which results in updated scripting guidance. At step 1518, a result of negotiation is recorded in the customer offer history, whether the result is acceptance, rejection, or another result.

Advantageously, embodiments of the disclosure provide a guidance system for account managers to view a snapshot of a customer that helps the account managers negotiate with customers. Typically, a customer is not motivated to talk to the account managers. The embodiments disclosed herein provide the account manager the relevant information needed to make best use of the short amount of time the account manager has to speak with the customer. According to various embodiments, both qualitative and quantitative information is available to the account managers. Furthermore, the dynamic scripting guidance provides intelligence that the account managers can use when negotiating with customers.

FIG. 16 is a block diagram of example functional components for a computing device 1600, according to one embodiment. One or more computing devices 1600 may be used to implement the functionality of the service provider 102, the acquirers 104, merchants 106, 114, financial institution 110, and issuer 112 in FIG. 1. In one embodiment, the computing device 1600 is configured to generate the user interface 300 shown in FIG. 3 and described above. Many other embodiments of the computing device 1600 may be used.

In the illustrated embodiment of FIG. 16, the computing device 1600 includes one or more processors 1601, memory 1602, a network interface 1603, one or more storage devices 1604, a power source 1605, output device(s) 1660, and input device(s) 1680. The computing device 1600 also includes an operating system 1608, a communications client 1640, and a local server 1665 that are executable by the client. Each of components 1601, 1602, 1603, 1604, 1605, 1660, 1680, 1608, 1640, and 1665 are interconnected physically, communicatively, and/or operatively for inter-component communications in any operative manner.

As illustrated, processors 1601 are configured to implement functionality and/or process instructions for execution within computing device 1600. For example, processors 1601 execute instructions stored in memory 1602 or instructions stored on storage devices 1604. Memory 1602, which may be a non-transient, computer-readable storage medium, is configured to store information within computing device 1600 during operation. In some embodiments, memory 1602 includes a temporary memory, area for information not to be maintained when the computing device 1600 is turned OFF. Examples of such temporary memory include volatile memories such as random access memories (RAM), dynamic random access memories (DRAM), and static random access memories (SRAM). Memory 1602 maintains program instructions for execution by the processors 1601.

Storage devices 1604 also include one or more non-transient computer-readable storage media. Storage devices 1604 are generally configured to store larger amounts of information than memory 1602. Storage devices 1604 may further be configured for long-term storage of information. In some examples, storage devices 1604 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The computing device 1600 uses network interface 1603 to communicate with external devices via one or more networks, such as one or more Internet and/or wireless networks. Network interface 1603 may be a network interface card, such as an Ethernet card, an optical transceiver, a radio frequency transceiver, or any other type of device that can send and receive information. Other non-limiting examples of network interfaces include Bluetooth®, 3G (3rd Generation) and WiFi® radios in mobile computing devices, and USB (Universal Serial Bus). In some embodiments, the computing device 1600 uses network interface 1603 to wirelessly communicate with an external device, a mobile phone, or other networked computing device.

The computing device 1600 includes one or more input devices 1680. Input device 1680 is configured to receive input from a user through tactile, audio, and/or video feedback.

Non-limiting examples of input device 1680 include a presence-sensitive screen, a mouse, a keyboard, a voice responsive system, a video camera, a microphone, or any other type of device for detecting a command from a user. In some examples, a presence-sensitive screen includes a touch-sensitive screen.

One or more output devices 1660 are also included in computing device 1600. Output device 1660 is configured to provide output to a user using tactile, audio, and/or video stimuli. Output device 1660 may include a display screen (part of the presence-sensitive screen), a sound card, a video graphics adapter card, or any other type of device for converting a signal into an appropriate form understandable to humans or machines. Additional examples of output device 1660 include a speaker, a cathode ray tube (CRT) monitor, a liquid crystal display (LCD), or any other type of device that can generate intelligible output to a user. In some embodiments, a device may act as both an input device and an output device.

The computing device 1600 includes one or more power sources 1605 to provide power to the computing device 1600. Non-limiting examples of power source 1605 include single-use power sources, rechargeable power sources, and/or power sources developed from nickel-cadmium, lithium-ion, or other suitable material.

The computing device 1600 includes an operating system 1608. The operating system 1608 controls operations of the components of the computing device 1600. For example, the operating system 1608 facilitates the interaction of communications client 1640 and local server 1665 with processors 1601, memory 1602, network interface 1603, storage device(s) 1604, input device 1680, output device 1660, and power source 1605.

As illustrated in FIG. 16, the computing device 1600 includes communications client 1640. Communications client 1640 includes communications module 1645. Each of communications client 1640 and communications module 1645 includes program instructions and/or data that are executable by the computing device 1600. For example, in one embodiment, communications module 1645 includes instructions causing the communications client 1640 executing on the computing device 1600 to perform one or more of the operations and actions described in the present disclosure. In some embodiments, communications client 1640 and/or communications module 1645 form a part of operating system 1608 executing on the computing device 1600.

One or more embodiments of the disclosure may be implemented on one or more computer-readable media executed by one or more processors.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer-implemented method for presenting a user interface on a computer display to an account manager of a financial institution, wherein a customer is a member of the financial institution, the method comprising:
displaying, in a single user interface screen:
an offer timeline of offers provided to the customer, wherein each offer is displayed as an icon in the offer timeline that corresponds to a result of the offer;
a timeline corresponding to payment history of the customer;
a graphical representation of the customer's debt over time;
indicators of the customer's bank account balances and loan balances;
an indicator of the customer's credit score;
one or more indicators corresponding to one or more personal situations of the customer;
one or more offers for the account manager to provide to the customer based on one or more of the offer timeline, the payment history of the customer, the customer's debt over time, the customer's bank account balances and loan balances, the customer's credit score, and the one or more personal situations of the customer; and
a customer category interface, wherein when the account manager selects a category corresponding to the customer, the single user interface screen displays one or more verbal cues for negotiation corresponding to the selected category.

2. The method of claim 1, further comprising: displaying, in the single user interface screen, a graphical representation of the customer's funds sources and debt sources.

3. The method of claim 1, wherein the icons in the offer timeline indicate one or more of: an offer accepted by the customer, and offer declined by the customer, no offer being made to the customer, payment accepted, payment promised by the customer, payment due by the customer, a payment returned to the customer, a pay date, and other financial event.

4. The method of claim 3, wherein the icons are color coded to identify different combinations of one or more of payment made, promise to pay, broken promise, returned payment, and payments received after due date but before cycle date.

5. The method of claim 1, wherein the graphical representation of the customer's debt over time comprise trend lines that show a relative increases and/or decreases of the customer's debt over time.

6. The method of claim 1, wherein the one or more personal situations of the customer comprise one or more of: active military, additional expenses, deceased, divorce, disputing charges, filing bankruptcy, fixed income, illness, no statement, out of work, oversight, overextended, reduced income, and student.

7. The method of claim 1, wherein:
if customer's personal situation comprises fixed income, then the single user interface is configured to display an income field;
if customer's personal situation comprises out of work, then the single user interface is configured to display income fields;
if customer's personal situation comprises reduced income, then the single user interface is configured to display an income field; and,
if customer's personal situation comprises student, then the single user interface is configured to display a graduation date field.

8. The method of claim 1, wherein the indicator of the customer's credit score comprises the customer's credit score as a number.

9. The method of claim 1, wherein the indicator of the customer's credit score comprises an arrow indicating a trend of the customer's credit score of a period of time, wherein the trend is either increasing, decreasing, or stable.

10. The method of claim 1, wherein the one or more verbal cues are organized in the single user interface screen by category, the categories including at least one of acknowledgment phrases, transitional phrases, solution-based questions, and benefits-based rebuttals.

11. A computer-implemented method for negotiating with a customer of a financial institution, the method comprising:
initiating, from a computer system associated with the financial institution, a telephone call to the customer;
displaying, in a single user interface screen on the computer system:
an offer timeline of offers provided to the customer, wherein each offer is displayed as an icon in the offer timeline that corresponds to a result of the offer,
a graphical representation of the customer's debt over time,
one or more indicators corresponding to one or more personal situations of the customer, and
one or more offers to provide to the customer based on one or more of the offer timeline, the customer's debt over time, and the one or more personal situations of the customer;
receiving, via the single user interface screen, a selection of a first customer category for the customer;
based on the first customer category, displaying, in the single user interface screen, a first set of verbal cues for negotiating with the customer;
receiving, via the single user interface screen, a selection of a second customer category for the customer; and
based on the second customer category, displaying, in the single user interface screen, a second set of verbal cues for negotiating with the customer.

12. The method of claim 11, further comprising: displaying, in the single user interface screen:
a timeline corresponding to payment history of the customer;
indicators of the customer's bank account balances and loan balances;
an indicator of the customer's credit score; and
a graphical representation of the customer's funds sources and debt sources.

13. The method of claim 11, wherein the first or second customer category comprises one of: a category associated with assisting the customer with more time and money, a category associated with providing tangible help now, a category associated with building a relationship with the customer, a category associated with generating communication with the customer, and a category associated with special handling.

14. The method of claim 11, wherein the one or more personal situations of the customer comprise one or more of: active military, additional expenses, deceased, divorce, disputing charges, filing bankruptcy, fixed income, illness, no statement, out of work, oversight, overextended, reduced income, and student.

15. A system comprising:
one or more databases storing:
customer biographical information,
customer payment history information,
customer bank account balance and loan balance information,
customer statement information,
customer credit score information, and
information related to one or more offers previously presented to a customer and one or more outcomes corresponding to presenting the one or more offers to the customer; and
a computing device executing one or more processors configured to generate a single user interface screen, the single user interface screen comprising:
an offer timeline of offers provided to the customer, wherein each offer is displayed as an icon in the offer timeline that corresponds to a result of the offer;
a timeline corresponding to payment history of the customer;
a graphical representation of the customer's debt over time;
indicators of the customer's bank account balances and loan balances;
an indicator of the customer's credit score;
one or more indicators corresponding to one or more personal situations of the customer;
one or more offers for the account manager to provide to the customer based on one or more of the offer timeline, the payment history of the customer, the customer's debt over time, the customer's bank account balances and loan balances, the customer's credit score, and the one or more personal situations of the customer; and
a customer category interface, wherein upon receiving a selection of a category corresponding to the customer, the single user interface screen displays one or more verbal cues for negotiation corresponding to the selected category.

16. The system of claim 15, wherein the computing device is operating by a financial institution of which the customer is a member.

17. The system of claim 15, wherein the category corresponding to the customer comprises one of: a category associated with assisting the customer with more time and money, a category associated with providing tangible help now, a category associated with building a relationship with the customer, a category associated with generating communication with the customer, and a category associated with special handling.

18. The system of claim 15, wherein the one or more verbal cues are organized in the single user interface screen by category, the categories including at least one of acknowledgment phrases, transitional phrases, solution-based questions, and benefits-based rebuttals.

19. The system of claim 15, wherein, upon receiving a selection of an updated category corresponding to the customer, the single user interface screen displays one or more verbal cues for negotiation corresponding to the updated category.

20. The system of claim 15, wherein for each of the one or more offers displayed in the single user interface screen, one or more benefits associated with accepting the offer is also displayed in the single user interface screen.
